(19) United States
(12) Patent Application Publication
(10) Pub. No.: US 2026/0321160 A1
(43) Pub. Date: Oct. 15, 2026

(54) SURGICAL PROCEDURE TRAINING APPARATUS AND METHOD

(71) Applicant: Arthrex, Inc., Naples, FL (US)

(72) Inventors: Jonathan Knopf, Naples, FL (US); David Knopf, Bonita Springs, FL (US); WenHong Neoh, Louisville, KY (US); Michael Moreland, Naples, FL (US); Michael A. Brown, Naples, FL (US); David Yang, Naples, FL (US)

(73) Assignee: Arthrex, Inc., Naples, FL (US)

(21) Appl. No.: 19/466,766

(22) Filed: Feb. 2, 2026

Related U.S. Application Data
(60) Provisional application No. 63/756,429, filed on Feb. 10, 2025.

(51) Int. Cl. G09B 23/34

(52) U.S. Cl. CPC G09B 23/34

(57) ABSTRACT

A physical anatomical model includes a model body representing an anatomical feature of an operating surface associated with a surgical procedure and a support body. The support body is formed from an at least partially transparent material and operably coupled to the model body. A target feature is disposed in the support body and positioned relative to the anatomical feature. The target feature is visible through the support body, such that a cutaway portion from a cutting operation is visible through the at least partially transparent material.

### CROSS-REFERENCE TO RELATED APPLICATIONS

This application claims priority under 35 U.S.C. § 119(e) and the benefit of U.S. Provisional Application No. 63/756,429 entitled SURGICAL PROCEDURE TRAINING APPARATUS AND METHOD, filed on Feb. 10, 2025, by Mark Shainwald, et al., the entire disclosure of which is incorporated herein by reference.

### BACKGROUND

As discussed in the following disclosure, the successful execution of various surgical procedures and techniques may require extensive training. In many cases, training may be executed on cadaveric tissue that may be generously donated to improve medical research and training. In addition to cadaveric tissue, artificial tissue may be implemented to simulate the anatomy of a patient. The disclosure provides for various improvements related to simulated anatomy that may be used for surgical procedure training and associated methods.

### SUMMARY

In various implementations, the disclosure provides for training apparatuses and associated methods for simulating surgical procedures. In various implementations, the disclosure may provide for a physical anatomical model that may include a model body representing an anatomical feature. The anatomical feature may form operating surface associated with a surgical procedure. The operating surface of the model body may include a plurality of contours that may be representative of an anatomical feature through which a practice cutting operating may be performed. The anatomical feature of the model body may be operably coupled to a support body that may be formed from an at least partially transparent material. A target feature may be disposed in the support body and positioned relative to the anatomical feature based on a target cutting path associated with the cutting procedure.

When applied in a training procedure, a surgeon or medical professional may utilize a cutting tool to simulate a cutting operation of the surgical procedure by cutting through the operating surface of the model body. In such operations, a cutting head of a cutting tool may destructively cut into or through the model body forming a cutaway portion along the target cutting path. In various implementations, a partially transparent material forming the support body may ensure that a target feature formed as a visible inclusion within the support body is visible through the at least partially transparent material. In this configuration, the cutaway portion of the support body may be visible through the partially transparent material, such that the target path or target cutting path associated with the target feature can be visually compared to the cutaway portion. Based on this comparison, the accuracy of the cutaway portion created by the cutting tool may be evaluated to determine the accuracy of execution of the corresponding practice technique.

In various implementations, the anatomical model may correspond to a sacrificial component that may be removable from a portion of a practice apparatus. For example, the model body and the support body of the anatomical model may correspond to an insert received by a model base of the practice apparatus. In this way, the portions of the practice apparatus that are cut during the practice procedure may be replaced without replacing the entirety of the practice apparatus. Further, in various implementations, the anatomical model may be implemented as a detachable assembly which may be selectively connected to the practice apparatus to form a portion of the physical anatomical model. The detachable assembly may comprise a plurality of interchangeable inserts, each of which may include the anatomical feature representative of one or more bone or tissue pathologies that may be associated with a practice surgical procedure. Accordingly, the disclosure may provide for a highly customizable surgical practice apparatus that may provide an improved simulation of a surgical procedure.

These and other features, objects and advantages of the present disclosure will become apparent upon reading the following description thereof together with reference to the accompanying drawings.

### BRIEF DESCRIPTION OF THE DRAWINGS

FIG. 1 is a projected environmental view demonstrating a surgical practice apparatus comprising a removable insert;

FIG. 2 demonstrates a projected view of a physical anatomical model, including a model body representing an anatomical feature associated with a surgical procedure;

FIG. 3A is a projected view demonstrating a removable model insert of a surgical practice model;

FIG. 3B is a projected view demonstrating a removable model insert of a surgical practice model;

FIG. 4 is a projected view demonstrating a practice procedure with a cutting tool engaging a model insert of a physical anatomical model;

FIG. 5 is a projected view demonstrating a model insert having a cutaway portion demonstrated relative to a target features extending along a target cutting path;

FIG. 6 demonstrates detailed views from a plurality of sides of the model insert demonstrating a plurality of inspection perspectives;

FIG. 7 demonstrates projected and detailed views of a model insert including a target feature extending along a target cutting path represented by a plurality of accuracy zones;

FIG. 8A is a projected view demonstrating a removable model insert of a surgical practice model;

FIG. 8B is a projected view demonstrating a removable model insert of a surgical practice model; and

FIG. 8C is a projected view of a support body of a physical anatomical model demonstrating the cutaway portion as a through cut along a cutting plane in accordance with the disclosure.

### DETAILED DESCRIPTION

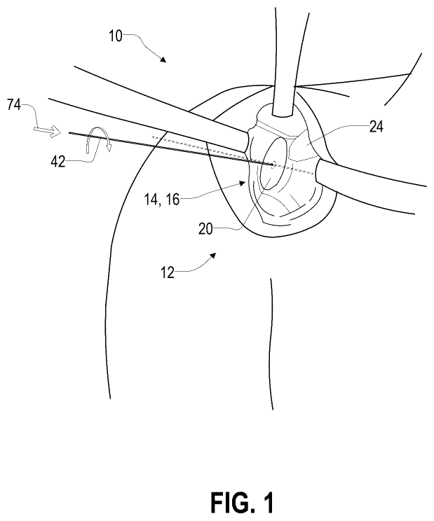

Referring generally to FIGS. 1-3, the disclosure provides for a surgical practice apparatus 10 including a simulated anatomical model 12 representative of a patient anatomy 14. In various implementations, the surgical practice apparatus 10 may be utilized to practice complex surgical procedures that may require visual alignment of one or more anatomical features 16 incorporated on the physical anatomical model 12. As previously discussed, the physical anatomical model 12 may be utilized as a readily accessible alternative to cadaveric tissue. In particular, the anatomical model 12 of the practice apparatus 10 may serve as a portable and reusable teaching aid that may be utilized to educate medical professionals for various procedures.

As demonstrated in FIGS. 1-3, the physical anatomical model 12 is demonstrated in reference to an exemplary shoulder anatomy. In general, the anatomical model 12 may include various simulated tissue layers, including bone, tendons, cartilage, and various forms of soft tissue (e.g., muscle, skin, fat). In particular reference to the exemplary anatomy associated with the practice procedure, the physical anatomical model 12 may form a portion of the practice apparatus 10. As shown, the anatomical model 12 may include a glenoid cavity 20, acromion 22, and corocoid process 24, which may be coupled to or form a portion of a model base 26. Accordingly, the anatomical model may include several anatomical features that may be modeled to provide an accurate simulation of a surgical practice procedure. In the example shown, the model base 26 may correspond to a scapula 28 or shoulder blade. Accordingly, the physical anatomical model 12 may be utilized to provide a physical simulated patient anatomy associated with various shoulder procedures.

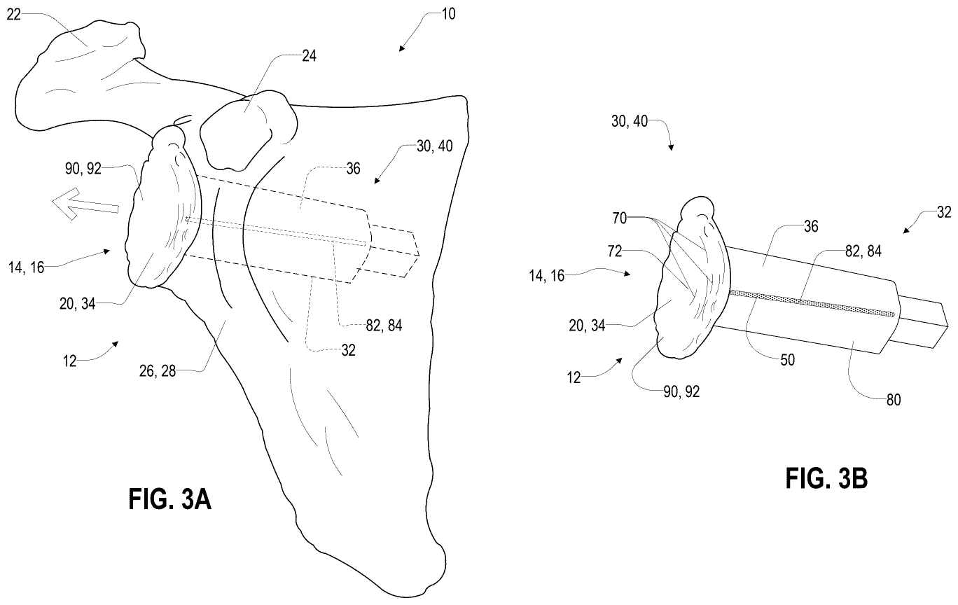

As best demonstrated in FIGS. 3A and 3B, the physical anatomical model 12 may be implemented as a detachable assembly 30, which may be in the form of an insert 32 including one or more of the anatomical features 16. In the example shown, the glenoid cavity 20 may form a model body 34 operably coupled to a support body 36, which may form the insert 32 coupled to the model base 26. In various implementations, the insert 32, including the model body 34 and the support body 36, may correspond to a sacrificial component 40 configured to be cut, resected, or otherwise manipulated to perform a practice cutting operation associated with a surgical procedure. In this way, the anatomical features 16 of the detachable assembly 30 may be customized separate from the remainder of the practice apparatus 10 for each practice trial to simulate a variety of anatomical variations and/or pathologies. Further, the detachable assembly 30 may be disposed of as a sacrificial component 40 of the practice apparatus 10 to limit waste and associated expense.

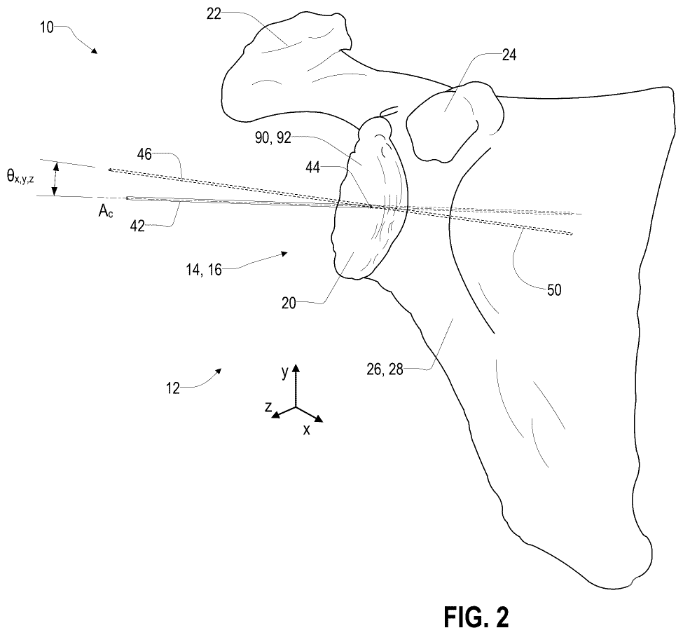

Still referring to FIGS. 1-3, the practice apparatus 10 may be implemented to perform a practice placement of a glenoid pin 42 through the glenoid 20. During such procedures, surgeons may utilize cutting tools in the form of drills or pin drivers to introduce an elongated pin, described herein as the glenoid pin 42, through the glenoid 20 and into supporting bone tissue of the scapula 28. In doing so, surgeons may attempt to align the glenoid pin 42 with an entry position 44 and align a cutting axis A_{C} with a target cutting trajectory 46. Variations in the position of the entry position 44 as well as the cutting trajectory 46 may result in corresponding variations in implant placement and ultimately effect patient outcomes. In the example shown in FIG. 2, the entry position 44 appears accurate while the angular error θ_{x,y,z} demonstrates considerable variation from the cutting trajectory 46. The result of the angular error θ_{x,y,z} or similar positional errors may drastically impact patient outcomes. Accordingly, practice associated with the successful placement of the glenoid pin 42 may be critical to the success of the exemplary shoulder replacement surgery as well as similar surgical procedures. By providing the model body 34 and the insert 32 in the form of the sacrificial component 40, the practice apparatus 10 may ensure that the associated surgical procedures may be practiced numerous times without replacing the entirety of the surgical practice apparatus 10.

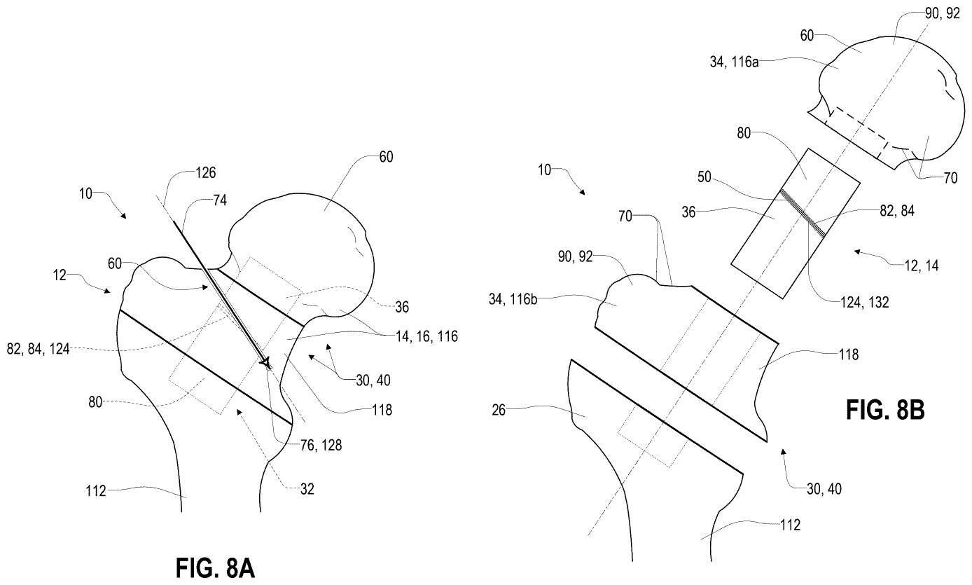

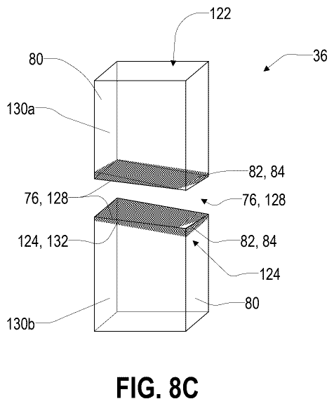

Though discussed as the entry position 44 and the target cutting trajectory 46 in specific reference to the glenoid 20 implementation of the model body 34, the practice apparatus 10 and anatomical model 12 may generally be implemented to represent a variety of anatomical features (e.g., knees, hips, vertebrae, etc.) that may generally be associated with cutting operations extending along a cutting path 50. Tools that may be utilized in conjunction with the practice apparatus 10 may include various cutting tools including, but not limited to, blades, drills, picks, burrs, mill, shavers, etc. Accordingly, the surgical practice apparatus 10 may be implemented as a training tool to support a variety of diverse practice procedures. At least one example of an additional surgical procedure is described later in reference to FIGS. 8A and 8B, demonstrating the removal of a femoral head 60 for a hip replacement.

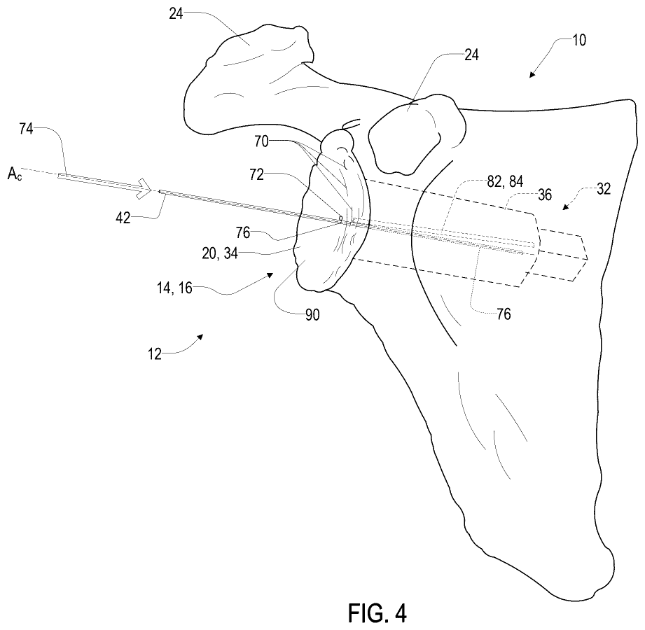

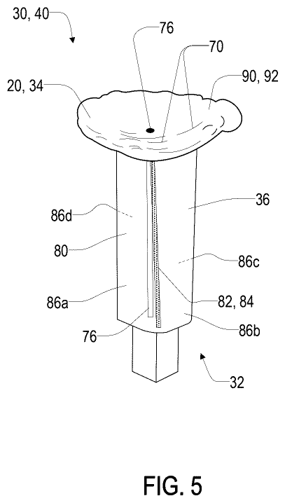

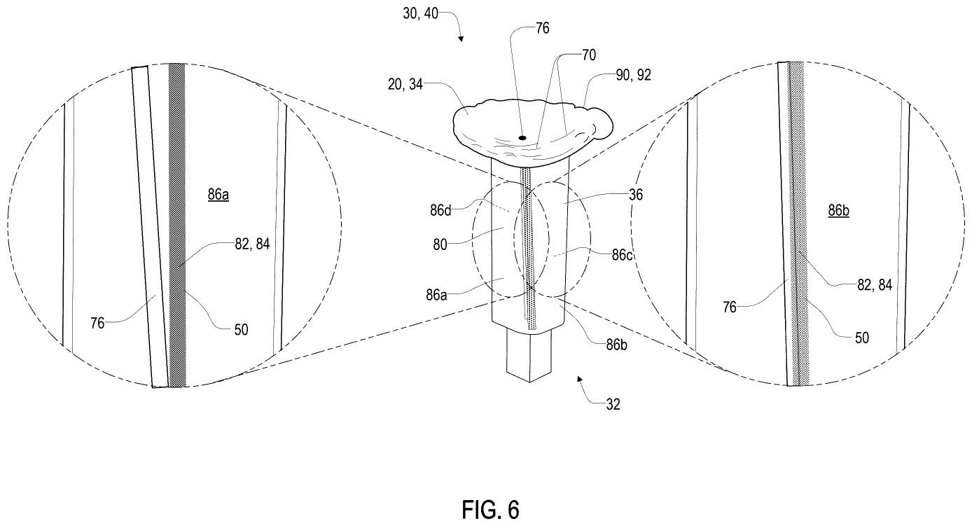

As shown in FIGS. 3A and 3B, the insert 32 forming the anatomical model 12 may include the model body 34, which may form one or more contour shapes 70 representative of the anatomical features 16. In FIG. 3A, the model body 34 is shown coupled to the support body 36. In this configuration, the support body 36 may correspond primarily to the insert 32 and extend into a corresponding receiving pocket or aperture in the model base 26. As shown, a target feature 72 may be formed or disposed within the support body 36 and anatomically positioned relative to the anatomical feature 16 formed by the contour shapes 70 of the model body 34. In this configuration, the execution of a cutting procedure with a cutting tool 74 (FIG. 4) may result in the formation of a cutaway portion 76 (FIG. 5) extending through the model body 34 as well as a portion of the support body 36 in connection with the model body 34. As later discussed in reference to FIGS. 5 and 6, removal of the insert 32 of the detachable assembly 30 may ensure that the resulting cutaway portion 76 formed by the cutting tool 74 is visually inspected relative to the target cutting path 50 represented by the target feature 72.

Referring generally to FIGS. 1-6, the support body 36 may be composed of at least partially transparent material 80 through which the target feature 72 may be visible as an inclusion 82 formed of a visually contrasting material 84 relative to the partially transparent material 80. Accordingly, the target cutting path 50 represented by the inclusion 82 formed by the visually contrasting material 84 may be observed through one or more body sides 86 of the support body 36. Further, the cutaway portion 76 may be visible through the partially transparent material 80 of the support body 36. In this way, the resulting cutaway portion 76 and associated cutting path may be compared to the visually contrasting material 84 reformed by the inclusion 82 to determine the accuracy of the practice procedure forming the cutaway portion 76 to the target cutting path 50. In contrast, if the detachable assembly 30 were not removable from the model base 26, the body sides 86 formed by the at least partially transparent material 80 of the support body 36 would not be visible for inspection. Accordingly, the detachable assembly 30 provides for the dual benefit of allowing the detachable assembly to be provided as a sacrificial component 40 while also allowing the cutaway portion 76 to be visually inspected by simply removing the insert 32 from the model base 26.

In various implementations, the model body 34, including the corresponding anatomical features 16 through which the target cutting path 50 extends, may be formed of a substantially opaque material 90. In this way, the model body 34 or one or more mask layers 92 or coatings may obstruct a view of the visually contrasting material 84 formed by the inclusion 82 during a practice procedure. As best illustrated in FIG. 2, the surgeon performing the practice procedure may be required to attempt to match the cutaway portion 76 to the target cutting path 50 while only being able to observe the anatomical features 16 and corresponding contour shapes 70 formed by the model body 34. Following the execution of the practice procedure, the insert 32 associated with the detachable assembly 30 may be removed, and the resulting cutaway portion 76 may be observed and compared to the target cutting path 50 represented by the inclusion 82 formed by the visually contrasting material 84 through the model body 36.

In various implementations, the at least partially transparent material 80 may correspond to various transparent or semitransparent materials and may correspond to a polymeric material. For example, the at least partially transparent material 80 may correspond to a transparent or semitransparent materials (e.g., polylactide [PLA], acrylonitrile butadiene styrene [ABS], polyethylene terephthalate glycol [PETG]). Similar materials may also be utilized to form the inclusion 82 with the visually contrasting material 84, which may correspond to an opaque, colored, or otherwise visually contrasting material relative to the transparent material 80. In some implementations, the material forming the support body 36, model body 34, and/or the inclusion 82 may be manufactured via a rapid prototyping or 3D printing process. Similarly, the model body 34 and support body 36 may be formed, and the inclusions 82 may be added in a post-processing step to drill and insert the inclusion 82 in the support body. The postprocessing may be formed through the insert 32 to avoid any visual reference of the inclusion 82 through the model body 34. Alternatively, the opaque material 90 may be applied as a mask layer 92 over the model body 34 to mask any visible trace associated with the formation of the inclusion 82. Accordingly, the practice apparatus 10 may be manufactured in various ways.

Still referring to FIGS. 1-6, the anatomical features 16 associated with the detachable assembly 30 may be manufactured to represent different features or physical pathologies associated with various forms of patient tissue, including bone, tendons, cartilage, and various forms of soft tissue. For example, the specific pathology of the model body 34 may be manufactured via 3D printing or a rapid prototyping process, such that a wide variety of representative or patient-specific pathologies may be represented by the anatomical features 16, including the contour shapes 70. Further, the target cutting path 50 (for example, entry position 44 in target cutting trajectory 46) may be adjusted to extend through the support body 36 based on a predetermined or optimal cutting path that may be associated with a preoperative plan tailored to the specific anatomy represented by the model body 34. In this way, the practice apparatus 10 may provide for training exercises to represent a wide variety of surgical procedures as well as exemplary or patient-specific anatomy to improve training exercises and assess their accuracy.

Referring now to FIGS. 5 and 6, the cutaway portion 76 formed by the exemplary cutting procedure is shown extending through the support body 36 relative to the visually contrasting material 84 formed by the inclusion 82. In FIG. 5, the difference or error between the cutaway portion 76 and the target cutting path 50 may be visually apparent. However, as shown in FIG. 6, observing the cutaway portion 76 through one or more of the body sides 86 may improve effectiveness of the visual comparison. For example, in FIG. 6, the cutaway portion 76 is shown observed through a first body side 86a and a second body side 86b. While the alignment between the cutaway portions 76 and the target cutting path 50 appears mostly aligned when observed from the second body side 86b, the angular and/or translational variation between the cutaway portion 76 and the target cutting path 50 becomes more readily apparent when viewing the cutaway portion 76 from the first body side 86a. Accordingly, by simulating the target cutting path 50 with the inclusion 82 extending through the at least partially transparent material 80 of the support body 36, the practice apparatus 10 may ensure that the cutaway portion 76 can be accurately compared to the target cutting path 50 about the cutting access A_{C}.

Though demonstrated as a generally rectangular shape including a first body side 86a, a second body side 86b, a third body side 86c, and a fourth body side 86d, it shall be understood that the improved observation of the cutaway portion 76 relative to the cutting path 50 may generally be provided by the insert 32 or support body 36 being generally formed by the at least partially transparent material 80 extending along a depth d over a portion of the cutting path 50. Accordingly, the support body 36 may be formed of a variety of shapes (e.g., circular, triangular, rectangular, etc.) while allowing the inclusion 82 to be viewed from multiple perspectives about the cutting axis A_{C}.

As generally described throughout the disclosure, the support body 36 may be formed of an at least partially transparent material 80. Further, the inclusion 82 may be formed of a visually contrasting material 84 relative to the at least partially transparent material 80. In general, the transparency of the support body 36 may be sufficient, such that the resulting cutaway portion 76 and the inclusion 82 may be visually observed through the at least one body side 86. In some implementations, the inclusion 82 may be of a material having a higher opacity than the support body 36. Additionally, the inclusion 82 representing the cutting path 50 may be of a contrasting color or shade of material extending through the at least partially transparent material 80 of the support body 36. As described, the at least partially transparent material 80 and the visually contrasting material 84 may correspond to one or more polymeric materials that may be formed via a rapid prototyping or 3D printing process. In this way, the support body 36 and orientation or position of the cutting path 50 represented by the inclusion 82 may be adjusted to align with the corresponding contour shapes 70 of the anatomical features 16 presented by the model body 34 to represent a variety of anatomic structures and preoperative plans. In this way, the surgical practice apparatus 10 may be implemented to support training for a wide variety of surgical procedures.

Referring generally to FIGS. 1-8, various techniques may be applied to construct or otherwise form the physical anatomical model 12 as disclosed. The physical anatomical models 12 may be constructed or otherwise formed utilizing various techniques and the resulting structures may not be limited to any particular manufacturing process unless otherwise specified. The physical anatomical models 12 may incorporate any of the features disclosed herein including a geometry of the respective virtual anatomical model(s), moduli of elasticity of the associated tissue(s), color scheme(s) and geometries associated with the target features 72 and corresponding contour shapes 70, simulated tissue or anatomic layers, fiber arrangements, etc. The physical anatomical model 12 may be formed to closely resemble or approximate a geometry of the associated anatomy, including soft tissue and bone. In implementations, the surgeon may interact with the physical anatomical model 12 such that portion(s) of the physical anatomical model may feel similar to soft (e.g., cancellous) bone tissue. The physical anatomical model 12 may be printed, molded, machined or otherwise formed according to the various parameters selected in the user interface. Various parameters may be utilized to form the physical anatomical model, including any of the parameters disclosed herein, such as density of bone and soft tissue, thickness of cortical bone, target and warning zones, patient age, etc.

In various implementations, the anatomical model 12 may be printed or otherwise formed based on the selected parameters. In some implementations, material may be printed in one or more layers on a substrate to establish the physical anatomical model. The material may be printed according to the configuration associated with the virtual anatomical model. In other implementations, the physical anatomical model is established by one or more casting operations. The physical anatomical model 12 may have a unitary construction or may have two or more components fixedly attached or otherwise secured to each other to establish a unit.

In some cases, the anatomical model 12 may be modeled and manufactured to practice or simulate a desired patient case, such as a prior, planned or hypothetical case associated with a surgical plan. In operation, the surgeon and associated professional staff may select anatomy associated with a pending patient case (e.g., pending surgical procedure) and the anatomical model 12 may be formed to represent the anatomy of a particular patient and/or patient group. Accordingly, the anatomical model 12 may be designed with a planning system allowing the surgeon or staff to select the specific anatomic features and topography after which the anatomical model is formed. In this way, the user may select a virtual anatomical model based on a particular patient, pathology, procedure, or surgical case to ensure that the training or practice experience associated with the anatomical model 12 provides meaningful experience for an intended practice procedure. In various cases, the model selected for the anatomical model 12 may correspond to an acquired CT scan of the patient. Accordingly, the surgeon may select the features of the anatomical model to be associated with a particular patient, classification of procedures, anatomical characteristics, anomalies, pathologies, or generic models to suit a wide variety of use cases.

The planning system and resulting anatomical models 12 may be manufactured based on generic or patient-specific models. Such models may be accessed in libraries of anatomical models categorized by anatomy, patient, pathology, case, etc. The parameters may include a patient classification and a defect category. Anatomical parameters may be arranged by category (e.g., joint, etc.), sub-category (e.g., shoulder, ankle, hip, etc.), model (e.g., glenoid, humerus, etc.) and anatomical size (e.g., small, medium, large), pathology, defect, etc. The categories may be subdivided by gross anatomy including surface anatomy (e.g., the external body), regional anatomy (e.g., specific regions of the body), and systemic anatomy (e.g., specific organ systems). Patient parameters associated with the anatomy may include sex, age, ethnicity, genetic or hereditary classifications, etc. Accordingly, the anatomical models 12 may be customized based on a wide variety of parameters to ensure the practice procedures provide the maximum insight for the desired learning or practice experience.

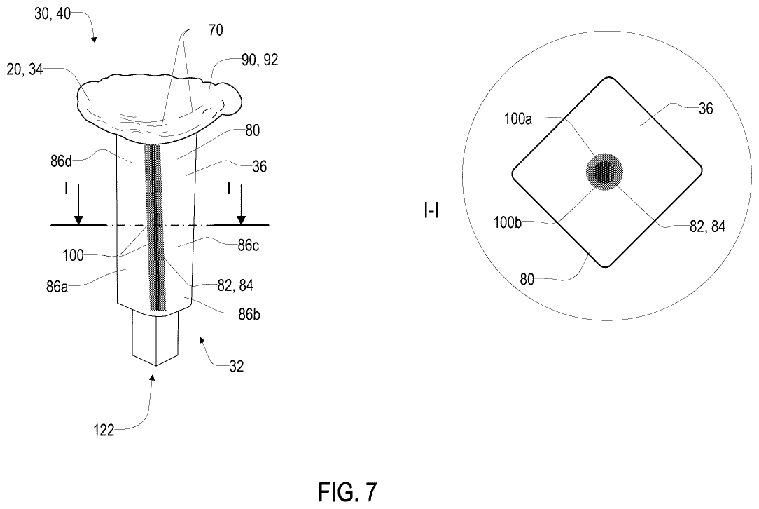

Referring now to FIG. 7, the target cutting path 50 may be represented by a plurality of target zones 100. In the example shown, the target zones 100 include a first target zone 100a and a second target zone 100b. In general, the target zones 100 may extend along the target cutting path 50 and represent increasing levels of deviation therefrom. For example, the first target zone 100a may extend to a first distance from the cutting path 50 and the second target zone 100b may extend to a second distance greater than the first distance. Accordingly, the second target zone 100b may represent an increased level of deviation from the cutting axis A_{C} than the first target zone 100a. Similarly, in implementations where the cutting path 50 corresponds to a cutting plane, the target zones 100 may extend perpendicular to the corresponding cutting plane or other complex cutting paths to demonstrate the variation of the cutaway portion 76 relative to the target cutting path 50.

The target zones 100 may be formed by materials similar to the inclusion 82. In the example shown, the first target zone 100a has a first opacity that is greater than the opacity of the second target zone 100b. Additionally, each of the target zones 100a, 100b has an increased opacity relative to the at least partially transparent material 80 of the support body 36. In this way, the target zones 100 may be visible through the at least one body side 86 of the support body 36 and provide for additional levels of visual comparison between the cutaway portion 76 and the target cutting path 50.

Referring now to FIGS. 8A-8C, an additional exemplary implementation of the anatomical model 12 is shown in the form of a femoral head 60 of a femur 112. In the example shown, the sacrificial component 40 of the detachable assembly 30 may include a plurality of model body portions 116 represented by the femoral neck 118 and a femoral head 60. Further, the model base 26 may correspond to a portion of the femur 112 adjacent to the femoral neck 118. In this configuration, the support body 36 may extend from a first model portion 116a corresponding to the femoral head 60 and through a second model portion 116b corresponding to the femoral neck 118. In this configuration, the second model portion 116b may correspond to a mask or intermediate portion of the model body 116 that may be removed or separated from the support body 36 to reveal the target cutting path 50. As further demonstrated in FIG. 8B, the first model portion 116a may also be detachable from the support body 36 to provide for further customization of the physical anatomical model 12.

In various implementations, the support body 36 may engage one or more openings 120 formed in the model base 26 and/or the model body 36 or model body portions 116. As best demonstrated in FIG. 8B, the support body 36 may correspond to a rectangular cross-section selectively inserted into the model base 26 and the model body portions 116a, 116b to operably couple and align the anatomical features 16 represented by the anatomical model 12. Accordingly, the support body 36 may provide for a transverse cross-section 122 that may align the model base 26 with the one or more model body portions 34, 116. Though described as rectangular, the transvers cross-section 122 may correspond to a variety of shapes that may rotationally align each of the anatomical features 16 of the physical anatomical model 12 about a longitudinal axis A_{L}.

Still referring to FIGS. 8A-8C, in various implementations, the target cutting path 50 may correspond to a target cut line 124 and target cutting plane 126. Referring now to FIG. 8C, the target cutting path 50 is demonstrated as a linear cut 128 extending relative to the visually contrasting material 84 formed by the inclusion 82. As demonstrated, the support body 36 is sectioned into a first portion 130a and a second portion 130b along opposing sides of the linear cut 128. As shown, the target cutting path 50 represented by the inclusion 82 demonstrates variations between the cutting plane 126 and the linear cut 128. While most of the linear cut 128 extends through a target zone 132, a small portion in a corner positioned between the body sides 86 in the foreground demonstrates a portion of the partially transparent material 80 of the support body 36. Such indications may demonstrate the error between the linear cut 128 completed by a practice procedure and the cutting plane 126 associated with the target cutting path 50. Similar to the target zones 100 previously discussed, the target cutting zone 132 may extend perpendicular to the cutting plane 126 associated with a preoperative plan and provide a visual indication identifying whether the linear cut 128 is inside or outside the target cutting zone 132. Further, though demonstrated as a singe cutting zone 132, multiple target cutting zones may be implemented, similar to the target zone 100 previously discussed. Accordingly, the physical anatomical model 12 may provide for a wide variety of anatomical representations to suit various surgical procedures to improve training while limiting the cost associated with replacing components of the surgical practice apparatus 10.

In the following description, reference is made to the accompanying drawings, which show specific implementations that may be practiced. Wherever possible, the same reference numbers will be used throughout the drawings to refer to the same or like parts. It is to be understood that other implementations may be utilized and structural and functional changes may be made without departing from the scope of this disclosure.

According to some aspects of the disclosure, a physical anatomical model includes a model body representing an anatomical feature of an operating surface associated with a surgical procedure; a support body of an at least partially transparent material operably coupled to the model body; and a target feature disposed in the support body and positioned relative to the anatomical feature of the operating surface. The target feature is visible through the support body.

According to various aspects, the disclosure may implement one or more of the following features or configurations in various combinations:
the operating surface includes a plurality of contours representative of the anatomical feature through which a practice cutting operation of the surgical procedure is performed;
the target feature is aligned with the contours of the anatomical feature according to a target cutting path;
the target feature extends through the support body along at least one of a cutting trajectory, a cutting plane, and a cutting profile of the surgical procedure;
the target feature comprises an inclusion extending through the at least partially transparent material;
the anatomic model is configured to be cut by a cutting tool in a practice procedure;
the practice procedure comprises the cutting tool cutting through the operating surface and removing a cutaway portion of the support body or the inclusion;
the cutaway portion of the support body or the inclusion is visible through the at least partially transparent material of the support body through at least one wall of the support body extending along a depth of a target cutting path represented by the target feature;
an overlap between the cutaway portion and the inclusion indicates an accurate execution of the cutting tool in the practice procedure;
the overlap is represented by a removal of at least a portion of the inclusion;
the inclusion is of a material having a greater opacity than the at least partially transparent material of the support body;
the inclusion is of a color that contrasts the at least partially transparent material of the support body;
the model body and the support body form a sacrificial component removable from a portion of a practice apparatus comprising the physical anatomical model;
the sacrificial component comprises an insert received by a model base of the practice apparatus;
the sacrificial component comprises a peg received within a receiving opening of the practice apparatus;
the model body and the support body form a detachable assembly selectively connected to form a portion of the physical anatomical model;
the detachable assembly comprises a plurality of interchangeable inserts representative of different anatomical pathologies and/or corresponding target cutting paths;
at least a portion of the operating surface of the surface model is of an opaque material through which the target feature is not visible;
the support body comprises a window of the at least partially transparent material through which the target feature is visible within the support body;
the target feature is proportioned representative of a size and shape of a cutting tool utilized for the surgical procedure;
removal of material in the support body that removes the target feature is representative of an accuracy of a practice operation of the surgical procedure;
the cutting tool comprises at least one of a blade (e.g., saw blade or cutting blade), a drill, a pick, a burr, a mill, and a shaver;
the support body comprises a plurality of sides extending along a cutting path represented by the target feature;
the plurality of sides of the support body form perimeter walls extending about the cutting path;
a view through the at least partially transparent material of the plurality of sides demonstrates the cutting path represented by the target feature from a different perspective; and/or
the support body extends from the model body along a cutting depth, and the view through a plurality of sides into the at least partially transparent material demonstrates the different perspectives about at least a portion of the cutting path.

According to another aspect of the disclosure, a method for providing feedback for a surgical procedure includes providing a target path comprising a visible inclusion extending through an at least partially transparent host material; performing a cutting routine removing material forming a cutaway portion through the host material along a cutting path; and viewing the cutaway portion through the host material of the inclusion, and visually comparing the cutaway portion to the visible target path through the at least partially transparent host material.

According to various aspects, the disclosure may implement one or more of the following features or configurations in various combinations:
visually comparing the cutaway portion to the visible target path through the at least partially transparent host material;
the cutting routine is processed through an anatomically modeled surface in connection with the host material;
the cutting routine is performed through a substantially opaque material of the anatomically modeled surface;
the substantially opaque surface through which a cutting tool passes into the host material masks a view of the target path represented by the visible inclusion;
the target path is aligned with the anatomically modeled surface based on a predetermined alignment of one or more features of the anatomically modeled surface;
the predetermined alignment of the target path with the anatomically modeled surface is based on a representative pre-operative plan for the surgical procedure;
the inclusion through the host material is aligned with a target region of the anatomically modeled surface;
the host material is a portion of a removable assembly of a surgical practice apparatus;
replacing the removable assembly, including the host material, such that the cutaway portion is replaced;
the removable assembly further comprises a tissue surface representing an anatomical feature associated with a surgical procedure;
the visible target path comprises at least one of a cutting trajectory, a cutting plan, and a cutting profile of the surgical procedure;
the cutting routine is processed through an anatomically modeled surface in connection with the host material;
the cutting routine is performed through a substantially opaque material of the anatomically modeled surface;
the substantially opaque surface through which a cutting tool passes into the host material masks a view of the target path represented by the visible inclusion;
the target path is aligned with the anatomically modeled surface based on a predetermined alignment of one or more features of the anatomically modeled surface;
the predetermined alignment of the target path with the anatomically modeled surface is based on a representative pre-operative plan for the surgical procedure;
the inclusion through the host material is aligned with a target region of the anatomically modeled surface;
the host material is a portion of a removable assembly of a surgical practice apparatus;
replacing the removable assembly, including the host material, such that the cutaway portion is replaced;
the removable assembly further comprises a tissue surface representing an anatomical feature associated with a surgical procedure; and/or
the visible target path comprises at least one of a cutting trajectory, a cutting plan, and a cutting profile of the surgical procedure.

According to some aspects of the disclosure, a physical anatomical model includes a model body representing an anatomical feature of an operating surface associated with a surgical procedure. A support body of an at least partially transparent material may be operably coupled to the model body. A target feature includes an inclusion extending through the at least partially transparent material of the support body and positioned relative to the anatomical feature of the operating surface. The target feature is visible through the support body, and the anatomic model is configured to be cut by a cutting tool removing a cutaway portion of the support body.

According to various aspects, the disclosure may implement one or more of the following features or configurations in various combinations:
the cutaway portion of the support body or the inclusion is visible through the at least partially transparent material of the support body through at least one wall of the support body extending along a depth of a target cutting path represented by the target feature.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

The claims:

1. A physical anatomical model comprising:
a model body representing an anatomical feature of an operating surface associated with a surgical procedure;
a support body of an at least partially transparent material operably coupled to the model body; and
a target feature disposed in the support body and positioned relative to the anatomical feature of the operating surface, wherein the target feature is visible through the support body.

2. The anatomical model according to claim 1, wherein the operating surface includes a plurality of contours representative of the anatomical feature through which a practice cutting operation of the surgical procedure is performed.

3. The anatomical model according to claim 2, wherein the target feature is aligned with the contours of the anatomical feature according to a target cutting path.

4. The anatomical model according to claim 1, wherein the target feature extends through the support body along at least one of a cutting trajectory, a cutting plane, and a cutting profile of the surgical procedure.

5. The anatomical model according to claim 1, wherein the target feature comprises an inclusion extending through the at least partially transparent material.

6. The anatomical model according to claim 5, wherein the anatomic model is configured to be cut by a cutting tool in a practice procedure.

7. The anatomical model according to claim 6, wherein the practice procedure comprises the cutting tool cutting through the operating surface and removing a cutaway portion of the support body or the inclusion.

8. The anatomical model according to claim 1, wherein the inclusion is of a material having a greater opacity than the at least partially transparent material of the support body.

9. The anatomical model according to claim 1, wherein the inclusion is of a color that contrasts the at least partially transparent material of the support body.

10. The anatomical model according to claim 1, wherein the model body and the support body form a sacrificial component removable from a portion of a practice apparatus comprising the physical anatomical model.

11. The anatomical model according to claim 10, wherein the sacrificial component comprises an insert received by a model base of the practice apparatus.

12. The anatomical model according to claim 1, wherein at least a portion of the operating surface of the surface model is of an opaque material through which the target feature is not visible.

13. The anatomical model according to claim 1, wherein the support body comprises a plurality of sides extending along a cutting path represented by the target feature.

14. The anatomical model according to claim 13, wherein the plurality of sides of the support body form perimeter walls extending about the cutting path.

15. The anatomical model according to claim 13, wherein the support body extends from the model body along a cutting depth, and the view through a plurality of sides into the at least partially transparent material demonstrates the different perspectives about at least a portion of the cutting path.

16. A method for providing feedback for a surgical procedure comprising:
providing a target path comprising a visible inclusion extending through an at least partially transparent host material;
performing a cutting routine removing material forming a cutaway portion through the host material along a cutting path;
viewing the cutaway portion through the host material of the inclusion; and
visually comparing the cutaway portion to the visible target path through the at least partially transparent host material.

17. The method according to claim 16, wherein the cutting routine is processed through an anatomically modeled surface in connection with the host material.

18. The method according to claim 17, wherein the cutting routine is performed through a substantially opaque material of the anatomically modeled surface.

19. A physical anatomical model comprising:
a model body representing an anatomical feature of an operating surface associated with a surgical procedure;
a support body of an at least partially transparent material operably coupled to the model body;
a target feature comprising an inclusion extending through the at least partially transparent material of the support body and positioned relative to the anatomical feature of the operating surface, wherein the target feature is visible through the support body; and
wherein the anatomic model is configured to be cut by a cutting tool removing a cutaway portion of the support body.

20. The anatomical model according to claim 19, wherein the cutaway portion of the support body or the inclusion is visible through the at least partially transparent material of the support body through at least one wall of the support body extending along a depth of a target cutting path represented by the target feature.
